(19) United States
(12) Patent Application Publication
(10) Pub. No.: US 2021/0024355 A1
(43) Pub. Date: Jan. 28, 2021

(54) SOLID BLEACH AND PROCESSES FOR MAKING SOLID BLEACH

(71) Applicant: OLIN CORPORATION, Clayton, MO (US)

(72) Inventors: David W. Cawlfield, Clayton, MO (US); Mary Beth Hill, Clayton, MO (US); Richard C. Ness, Clayton, MO (US)

(73) Assignee: OLIN CORPORATION, Clayton, MO (US)

(21) Appl. No.: 17/062,296

(22) Filed: Oct. 2, 2020

Related U.S. Application Data
(63) Continuation-in-part of application No. 17/043,206, filed on Sep. 29, 2020.
(60) Provisional application No. 62/649,910, filed on Mar. 29, 2018.

(51) Int. Cl. C01B 11/06

(52) U.S. Cl. CPC C01B 11/068; C01P 2006/90; C01B 11/062

(57) ABSTRACT

Disclosed herein are processes for producing highly concentrated bleach slurries containing a mixture of crystals of solid sodium hypochlorite pentahydrate in a liquid phase saturated in sodium hypochlorite and containing sodium hydroxide or other alkaline stabilizers. Bleach slurries and compositions exhibiting enhanced stability are also disclosed.

### CROSS-REFERENCE TO RELATED APPLICATIONS

This application is a continuation-in-part of U.S. non-provisional application Ser. No. 17/043,206, filed on Sep. 29, 2020, which is a national stage application of PCT/US2019/022909, filed Mar. 19, 2019, which claims the benefit of priority of U.S. Provisional Application No. 62/649,910, filed on Mar. 29, 2018, the disclosure of each of the aforementioned applications is hereby incorporated by reference in their entirety.

### FIELD OF THE INVENTION

The present disclosure generally relates to the preparation of highly concentrated bleach slurry and the resulting highly concentrated bleach.

### BACKGROUND OF THE INVENTION

There are many uses for sodium hypochlorite, commonly known as bleach, in industrial, utility, and residential applications. In many large-scale applications, sodium hypochlorite has traditionally been produced on-site through the addition of chlorine and alkali to water. While shipping liquefied chlorine gas in portable cylinders or in rail cars is the most common way to obtain the chlorine used to make bleach, the hazards of handling, shipping, and storing liquefied chlorine have increased the liability-related-costs of this approach. Alternatives to handling liquefied chlorine gas include the production of chlorine or sodium hypochlorite by electrolysis. Electrolysis is the conversion of sodium chloride containing brine to a solution containing sodium hypochlorite in an undivided electrochemical cell. This process has the advantage of producing sodium hypochlorite without the separate production of gaseous chlorine and solutions containing caustic soda, which can be performed on-site. The principal disadvantage of on-site direct electrolysis to make bleach is that high conversion of salt to bleach is not achievable simultaneously with high coulometric yield of bleach from current. Another problem encountered with direct electrolysis is the limited life of electrodes in this application. Yet another problem with direct electrolysis is the undesirable formation of chlorate, either by thermal decomposition of hypochlorite solutions or by the electro-oxidation of hypochlorite at the anode.

Indirect electrolysis of salt to produce chlorine and caustic soda, typically performed in a membrane-cell electrolyzer is a means to achieve high conversion of salt and high coulometric yield. The chlorine and caustic soda co-produced by this means can be combined in a suitable reactor to produce bleach solutions. However, such indirect production of bleach requires substantial investment in equipment, especially including equipment for brine purification, but also including equipment for handling gaseous chlorine. Indirect production of bleach is less suitable for small on-site applications, but is the preferred means to produce bleach at an industrial scale. Such production is typically optimized by selecting a location in close proximity to electric power generating assets and where salt can be obtained inexpensively. It is typically impractical to produce bleach by indirect electrolysis at most locations where it is needed. Transportation of bleach solutions is limited by the solubility of sodium hypochlorite in water and by the limited stability of these solutions. Transportation cost of bleach solutions of 15-25% concentrations is higher than the cost of transporting the reactants (50% caustic soda and liquefied chlorine gas) used to produce bleach conventionally, because more mass and volume must be transported per unit of sodium hypochlorite delivered.

There are two different indirect processes for producing bleach solutions: the first is the equimolar bleach process, and the second is the salt removal process. The equimolar process involves a chlorination reaction in which all products of reaction remain in solution. The overall formula for this reaction is represented by the formula:

2 NaOH+Cl₂ [symbol] NaOCl+NaCl+H₂O.

The equimolar process is referred to as the equimolar process because the ratio of sodium chloride to sodium hypochlorite in the product is at least 1:1 on a molar basis. The chlorate formation and the presence of sodium chloride impurity in commercial-grade caustic soda used increases the ratio of the chloride to hypochlorite ratio to slightly above 1:1. Equimolar bleach (EMB) has limited concentration to about 16 wt % bleach, so as to avoid crystallization of salt during storage or transportation. The presence of salt adds no value to the product and increases its decomposition rate.

Competing with this desired, bleach forming reaction is an undesired decomposition of bleach to form sodium chlorate:

3 NaOCl [symbol] NaClO₃+2 NaCl

In the equimolar processes, a small excess of alkalinity is required to stabilize the product. Rapid mixing of chlorine into the sodium hydroxide, uniform cooling, and maintaining excess alkalinity in the mixing zones are known to minimize the formation of chlorate.

Another undesired reaction that occurs when excess chlorine reacts with water and bleach to create hypochlorous acid:

Cl₂+H₂O+NaOCl [symbol] [symbol] 2 HOCl+NaCl

Hypochlorous acid facilitates the decomposition of hypochlorite to chlorate. The presence of excess alkalinity converts hypochlorous acid to hypochlorite, so the formation of the undesired chlorate is minimized.

The second class of processes may be referred to as the salt removal processes. These processes remove salt (by allowing it to crystallize and then removing the solid salt) during the chlorination reaction and they use less dilution. Bleach solutions containing as much as 28 wt % bleach may be formed, and the ratio of chloride to hypochlorite is typically less than 0.4 wt %. Lower overall yields of bleach from this class of processes are a problem. One issue is that chlorate formation is more rapid. A second is that larger reactors are needed, because the salt crystals need to grow to an average size greater than 300 microns, which allows them to be removed by settling or filtration. Some yield losses are also incurred during the salt separation, as some bleach is retained on the moist filter (or centrifuge) salt cake.

Sodium hypochlorite pentahydrate, a salt containing sodium hypochlorite and water, is stable at temperatures below about 25° C., melts between temperatures of about 25 to 29° C., and affords a strong solution of sodium hypochlorite and water. Typically, sodium hypochlorite pentahydrate crystals are long and needle shaped. These crystals have an undesired low bulk density arising from this crystal shape. The crystals also rapidly decompose, when allowed to come in contact with air. For example, crystals exposed to the atmosphere overnight decomposed to form a dilute liquid, even when stored at low temperatures. It is theorized that this rapid decomposition occurs due to contact with carbon dioxide on the surface of the crystals. The inventors determined that when crystals were produced with high purity and little liquid remaining on their surface, the crystals were even more sensitive to the presence of air, i.e., they decomposed. However, the inventors also found that adding excess base, as described herein, improved the stability of the crystals.

When bleach solutions are produced that contain greater than about 25 wt % sodium hypochlorite, solid pentahydrate crystals can begin to form upon chilling of these solutions below 10° C. However, even at this temperature, concentrated bleach solutions decompose more rapidly than desired. Bleach solutions may be prepared at temperatures—below the equilibrium point at which pentahydrate crystals will form and maintained without the formation of pentahydrate, provided a seed crystal is not present. However, in large-scale transportation, the complete absence of seed crystals cannot be guaranteed. When bleach solutions are chilled to temperatures at which sodium hypochlorite pentahydrate crystallizes and a seed crystal is present, crystals form, and the resulting crystallized bleach containing material cannot easily be pumped, as the crystals clog pipelines and hoses. Consequently, this solid containing material is not easily removed from transportation containers.

Formation of pentahydrate crystals represents a barrier to the effective transportation and distribution of bleach solutions having more than about 25 wt % sodium hypochlorite at temperatures below about 10° C.

Developing improved methods of making concentrated bleach, would be advantageous, because it would help to reduce manufacturing and/or shipping costs, among other benefits. And preparing more stable, concentrated bleach slurries and solids is desirable, because material exhibiting reduced degradation over time can be stored longer and shipped farther, which helps to reduce costs.

### SUMMARY OF THE INVENTION

Disclosed herein are processes for preparing bleach, the process comprising:

Making a mixture comprising sodium hydroxide, water, and chlorine in a reactor;

Forming strong bleach and NaCl, wherein at least some of the NaCl is a solid;

Separating strong bleach from at least some of the solid NaCl and removing material comprising at least some of the solid NaCl from the reactor;

Cooling the strong bleach in a cooler to afford cooled strong bleach;

Introducing the cooled strong bleach into a bleach crystallizer, where at least some bleach crystals form;

A stream comprising cooled strong bleach and bleach crystals leaves the bleach crystallizer and at least a portion of this stream enters a separator, where at least some of the bleach crystals are separated from the rest of the stream. Various recycle streams may be used to reduce cost and facilitate the formation of the desired, solid bleach, i.e., sodium hypochlorite pentahydrate.

Also disclosed herein are compositions comprising solid bleach, water, and a basic compound comprising sodium hydroxide, sodium carbonate, sodium metasilicate, sodium silicate, sodium phosphate, sodium aluminate, sodium borate, or mixtures of two or more thereof, where the basic compound was not prepared during the preparation of the solid bleach.

Other features and iterations of the invention are described in more detail below.

### BRIEF DESCRIPTION OF THE FIGURES

FIG. 1: is a schematic illustrating material flows and conditions in one embodiment of the concentrated bleach process.

FIG. 2: is a graph of the wt % NaOCl v. time, when different amounts of base are added to the NaOCl.

FIG. 3 is a graph comparing the decomposition rate of equimolar bleach diluted to 12.5 wt % sodium hypochlorite to solid bleach made according to the processes described herein diluted to 12.5 wt % sodium hypochlorite. The data generated at 20° C.+/−1° C. shows a 2× improvement in stability of the dissolved and diluted sodium hypochlorite pentahydrate made according to the processes described herein compared to EMB bleach at the same conditions. Data points shown are average of two duplicates.

FIG. 4 is a graph comparing the stability over time of solid bleach made according to the processes described herein, where the bleach contains varying levels of caustic. Samples stored at 10° C.+/−1° C.

FIG. 5 is a graph illustrating hypochlorite decay at different wt % of base (caustic) at various storage temperatures.

### DETAILED DESCRIPTION OF THE INVENTION

As described above, disclosed herein are methods of preparing highly concentrated bleach slurries and stable, highly concentrated bleach compositions. One aspect of the present disclosure encompasses reacting aqueous NaOH with a chlorinating agent in a reactor, to form bleach. Preferably, the isolated bleach made according to the processes described herein is a slurry or solid bleach.

Chlorinating Agent

Preferably, the chlorinating agent is chlorine. The chlorine may be a gas, a liquid or a mixture thereof. The chlorine gas may be a wet gas and the chlorine liquid may be a dry liquid. If chlorine liquid is used, it will vaporize, which helps to cool the reaction mixture. Internal and/or external heat exchangers may be used to control the reaction temperature. Examples of coolers include plate and frame heat exchanger, shell and tube heat exchanger, scraped surface heat exchanger, and vacuum evaporation coolers.

Sodium Hydroxide

Aqueous sodium hydroxide is used in the processes disclosed herein. Typically, the concentration of the sodium hydroxide is at least about 10 wt %, 15 wt %, 20 wt %, 24 wt %, 25 wt %, 30 wt %, 35 wt %, 40 wt %, 45 wt %, 50 wt % or higher. Higher concentrations of sodium hydroxide may be used. In one embodiment, the NaOH is greater than 20 wt %. In another embodiment, it is at least 24 wt %. The aqueous sodium hydroxide may be prepared on site or it may be purchased.

Reaction Conditions

In one embodiment, the reactor is maintained at a temperature of less than about 30° C. More preferably, the reactor is maintained at a temperature of less than about 25° C. Still more preferably, the reactor is maintained at a temperature of about 15° C. to about 20° C. Even more preferably, the temperature is about 18 to about 20° C. It is generally preferred to maintain the temperature of the reactor at lower temperatures, rather than higher temperatures. This helps to prevent degradation of the strong bleach via the formation of chlorate. At lower temperatures than about 15° C., strong bleach will begin to form pentahydrate crystals in the reactor and/or cooler. This can foul the cooler and reduce the process yield. To be clear, it is desirable to minimize the co-crystallization of the pentahydrate crystals and NaCl, as co-crystallization reduces the yield of the pentahydrate crystals. At temperatures higher than about 25° C., and especially above 30° C., the strong bleach decomposes at a rate that produces an undesired level of chlorate, which reduces yield. By reducing formation of chlorate in the reactor, less chlorate accumulates from filtrate recycle, so that at equilibrium, the filtrate carried over with the solid in the separation step is sufficient to entirely eliminate the requirement for a filtrate purge.

The pressure in the reactor is typically close to ambient pressure, or in one variation of the process, may be less than ambient pressure, e.g., under vacuum defined by the vapor pressure of water in equilibrium with the aqueous bleach solution, because there are no other volatile components of the reactor. A typical value of operation under vacuum is 0.2 psia. In this variation of the process, water vapor is evaporated from the surface of the bleach to provide cooling and remove a portion of the heat of reaction of chlorine with sodium hydroxide. The temperature in the reactor may be maintained by running the reaction at a pressure less than ambient pressure and further in combination with one or more external coolers. If the reaction is performed at ambient pressure, the temperature is maintained through the use of coolers.

In the Reactor and the Flow of Materials

As the strong bleach forms, sodium chloride (salt) also forms. The salt becomes super saturated in the reaction mixture and at least some of the salt precipitates out. If salt is already present in the reaction mixture, this can help to facilitate the precipitation of the salt.

Typically the concentration of the strong bleach within the reactor is less than about 30 wt % NaOCl, or less than about 25 wt % NaOCl, or greater than about 10 wt % NaOCl, or greater than about 15 wt % NaOCl. Variables that affect this concentration are the ratio of recycled bleach solution to chlorine and/or caustic.

As the salt (NaCl) precipitates out, the remaining reaction mixture becomes enriched in bleach. The salt is removed by decanting the reaction mixture from the salt, allowing the salt to settle and removing at least some of the settled salt from the bottom of the reactor, filtering the reaction mixture, using a centrifuge or using two or more of these separation techniques, in combination. Preferred centrifuges for salt separation include a decanter-style centrifuge, a screen-scroll, a worm/screen or a screen-bowl centrifuge. The solid bowl centrifuge can obtain rapid and essentially complete removal of salt from the bleach. But when salt is separated efficiently in a settling zone of the reactor, the screen-bowl centrifuge can produce a salt cake with less liquid content, which improves the process yield. When a thicker salt slurry is required, a hydrocyclone may be used to concentrate the salt slurry prior to feeding it to the centrifuge. A benefit of screen scroll and worm screen centrifuges is their ability to accept a low concentration salt slurry.

If desired, at least some of the strong bleach is withdrawn from the reactor, cooled in a cooler, and then recycled to the reactor. The portion of the reaction mixture that is withdrawn from the reactor is withdrawn from a region of low solids concentration. Often, this is the upper portion of the reactor.

When the chlorination reactor does not contain a settling zone, where salt particles are separated from the reaction mixture, the reactor itself is smaller. But in such cases, the slurry circulating through the pump and cooler is more abrasive to the pump and is more likely to foul the cooler.

The reaction mixture in the reactor is typically stirred, for example by the use of an impeller, or by inducing a jet of flow of bleach through the use of a nozzle. In an embodiment, the nozzle is near the bottom of the reactor. Other mixing or stirring means known in the art may be used. Combinations of two or more mixing methods may also be used.

The residence time of the strong bleach in the reactor is about 0.25 to about 5 hours, where residence time is the ratio of the liquid-filled volume of the reactor divided by the flow rate of the strong bleach with some NaCl removed from it. In an embodiment, the residence time is 0.5 to two hours. To minimize decomposition of the strong bleach in the chlorination reactor, a lower residence time is desired. When the process is performed at the lower-end of the preferred temperature range, a longer residence time may be employed.

An excess of sodium hydroxide is present in the chlorination reactor and in the strong bleach separated from salt. This excess sodium hydroxide is from about 1 to about 10% by weight of the liquor after salt has been removed, or about 2% to about 8%, or about 3% to about 6%. In one embodiment, the excess sodium hydroxide is about 3% to about 4% by weight of the liquor after salt has been removed. The excess sodium hydroxide improves the efficiency of the reactor by raising the pH of the reactor in the mixing zone where chlorine is introduced. When the excess sodium hydroxide used is too low, the localized pH in the chlorine mixing region may be as low as about 5 to about 7, and when the pH of sodium hypochlorite solutions is this low, rapid decomposition takes place. Some or all of this excess may be provided by the recycle of alkaline weak bleach liquor from the pentahydrate crystallizer.

Once at least some of the solid salt is removed, the strong bleach is cooled in a cooler, and cooled strong bleach is formed. Examples of coolers include a plate and frame coolers, shell and tube coolers, and vacuum evaporation coolers. If desired, two or more coolers may be used. A portion of the cooled strong bleach may be recycled to the reactor. The cooled strong bleach then enters the bleach crystallizer, where at least some bleach crystals (sodium hypochlorite pentahydrate crystals) form. The temperature of the cooled strong bleach is about 15° C. or more.

The bleach crystallizer is connected to at least one cooler, which help to maintain the temperature in the crystallizer. In one embodiment, the cooler is at least one of a shell-and-tube heat exchanger or a scraped-wall heat exchanger.

The temperature in the bleach crystallizer is colder than that in the reactor. The crystallizer can be run at temperatures as low as about −15° C., at which temperature the water in the solution may freeze. More commonly, the crystallizer is operated at approximately 0° C. and the material leaving the crystallizer is at a temperature of about −0.5 to −5° C.

A heat balance on the process shows that heat is added from the reaction of chlorine with caustic soda to form hypochlorite (this reaction is exothermic), and through the heat of dilution of caustic soda (which is also exothermic). A minor amount of heat is generated from the inefficiency of pumping and by the undesired decomposition of hypochlorite. Heat is also added during crystallization from the heat of fusion of the sodium hypochlorite pentahydrate. Heat is typically removed from the process in two locations, the reactor cooler, and the crystallizer cooler. The heat of crystallization is mostly, if not entirely, removed by the crystallization cooler.

As noted above, performing the reaction at sub-ambient pressures will cause evaporation, which may also help to maintain the reaction temperature. Because the heat addition to the process occurs almost entirely in the chlorination reactor and its circulation loop, the chlorination reactor operates at substantially higher temperature than the crystallizer. The solubility of sodium chloride is insensitive to temperature, whereas the solubility of sodium hypochlorite pentahydrate (bleach crystals) is highly temperature dependent. Furthermore, solubility of each solid is strongly dependent on the concentrations of the total amount of sodium ions in solution. For this reason, a difference of operating temperature between reactor and crystallizer is critical to the successful operation of this process so that in the chlorination reactor and its circulation loop, predominantly (and preferably only) sodium chloride is precipitated, while in the bleach crystallizer, predominantly (and preferably only) sodium hypochlorite pentahydrate is precipitated. While it has been shown that the process can be operated over a wide range of temperatures, the separation in operating temperatures that is most preferred can be described by the portion of cooling load that occurs in each cooling loop. When more than about 60% of the heat removed from the process occurs in the reactor cooling loop, the operating temperature of the reactor is too close to that of the crystallizer. When the reactor cooler outlet temperature drops below about 15° C., bleach crystals begin to co-precipitate with salt, which is undesirable. At the other extreme, the process can be operated with all of the heat removed by the crystallizer cooler. In this case, the temperature difference between the chlorination reactor and bleach crystallizer is maximized. At a bleach reactor operating temperature above about 40° C., hypochlorite decomposition is too high and overall yield drops below 90% for the process. Ideally, between 30% and 50% of the total heat is removed through the crystallizer cooler. When all of the heat removed from the process is removed in the crystallizer, the recycle rate of the cold filtrate from the crystallizer to the reactor controls the temperature of the chlorination reactor.

For a shell-and-tube type of cooler, fouling of the cooler surfaces is reduced by minimizing the temperature drop across the cooler, but when the cooler is a scraped-wall design, the temperature drop may be larger. When the temperature drop across the crystallizer cooler is low, the circulation rate through the cooler must be larger to remove the heat, such as the heat of crystallization that is given off when crystals form. In one embodiment, more than one cooler is used.

In an embodiment, the chlorination reactor is maintained at a temperature less than 25° C., and more preferably, about 15 to about 20 degrees C., and the chlorination reactor typically operates at a temperature that is about 15-20° C. warmer than the bleach crystallizer.

When the cooler is a shell-and-tube cooler, the tubes are larger than about 1 cm inside diameter, and the cooler has a tube-side velocity of greater than about 2 meters per second. The exact size of the cooler and the tube side velocity depend on the amount of bleach being prepared. Coolant for the crystallizer may be a refrigerant that boils inside the cooler jacket. This direct-cooling design minimizes operating costs by reducing the mechanical and/or electrical energy input required.

The settled solids content of the crystallizer is the volume fraction observed when a sample of the slurry is allowed to settle for a period of time of at least 1 minute in a container that minimizes temperature change of the slurry. A settled solids content greater than about 70% has been observed to make plugging of the heat exchanger, pump, or slurry circulation lines more likely and causes a high viscosity of the slurry. At a settled solids content of less than about 20%, supersaturation of the crystallizer occurs, and fine crystals with an L/D ratio greater than about 10/1 are likely to form. These have an undesirable effect on the product. Operating the crystallizer within this window can be achieved by recycling a portion of the filtrate to the crystallizer or by changing the crystallizer operating temperature to be closer to that of the chlorination reactor.

The stream leaving the crystallizer is then treated, by removing at least some of the bleach crystals. In one embodiment, all of the bleach crystals are removed. The stream may be filtered using gravity or vacuum filtration. Alternatively, a centrifuge may be used. Vacuum filtration is generally quicker than gravity filtration. The filtration apparatus or centrifuge may be insulated, so as to help maintain the temperature of the filtrate. When vacuum filtration is used, air passing through the crystals contains carbon dioxide, which reacts with at least some of the excess, residual sodium hydroxide present in the filtrate, and reduces the alkalinity of the crystalline product. This reaction with carbon dioxide is believed to be undesirable, as it makes the product less stable. A preferred way to minimize the reaction with carbon dioxide is to capture the air which is drawn through the filter and recycle it. For example, the outlet of a vacuum pump that provides vacuum to the filter is returned to a shroud covering the outside of the filter, thereby preventing additional ambient air from being drawn through the filter. The isolated bleach crystals contain less than 10% liquid (not including the water in the pentahydrate crystals). Alternately, they contain less than 5% liquid (not including the water in the pentahydrate crystals). The residual liquid bleach may be entirely or partially recycled to the chlorination reactor. If any residual bleach is recycled, at least about 10% is recycled. More preferably about 50% to 100% of the residual liquid is recycled to the chlorination reactor. By recycling filtrate, the concentration of sodium hypochlorite in the reactor is reduced, thereby further lowering decomposition rates of bleach in the reactor and making it possible to achieve overall yield of bleach from chlorine of 99% or greater.

Any filtrate that is not recycled is typically sold as conventional equimolar bleach. However, excess alkalinity from the reactor remains in the filtrate and not the crystals, so the excess alkalinity in the reactor must be minimized in order to avoid producing a byproduct stream with an undesirably high alkalinity, i.e. an alkalinity which is higher than acceptable for customers of conventional bleach solution.

When at least some filtrate is recycled the reactor is most advantageously operated with about 1% to about 10% excess alkalinity so as to minimize the likelihood of over-chlorination in the reactor and reducing chlorate formed when chlorine is added to the reactor. Crystallizing sodium hypochlorite pentahydrate from liquor containing 1 to 10% sodium hydroxide has been shown, unexpectedly, to yield product with equal purity and with greater stability, than when crystallizing from bleach prepared with low excess alkalinity.

In one embodiment, the separated bleach crystals are combined with water and/or filtrate from the prior filtration step to form a bleach slurry product. In an embodiment, the separated bleach crystals are combined with water to form a bleach slurry product. In another embodiment, the bleach crystals are combined with filtrate from the prior filtration step.

In the above processes, water is optionally added to the reactor, the bleach crystallizer, the separator or combinations of at least two thereof. The skilled person will appreciate if and when water is need to maintain a lower viscosity and/or facilitate the reaction, for example. The overall amount of water entering the process through the addition of reactants and optional water must equal the water leaving in the product stream. This water balance is best maintained by a skilled operator by purging a portion of the filtrate (as described above) to produce a co-product bleach solution. The coproduct production is ideally minimized by minimizing water addition and using only caustic soda greater than 40 wt % NaOH, preferably at least 50 wt % NaOH.

Crystals

The crystals may be reduced in size by comminution. This will afford a slurry that can be pumped and/or transferred using hoses, piping and other equipment typically used when handling conventional bleach. The size of the crystals, and in particular their length, may be reduced using means known in the art, such as mechanical crushing, milling, high-shear mixing, abrasion, or combinations of two or more thereof. Milling of crystals is performed to minimize the viscosity.

In one embodiment, pentahydrate crystals have a length to diameter ratio of below about 5:1. In another embodiment, the ratio is less than about 4:1, which helps to ensure a pumpable slurry is produced. At L/D ratios higher than about 5:1, the slurry is less flowable. Potentially, crystallization process conditions can be identified that will produce this desired crystal shape without a mechanical step. In one embodiment, the crystals have been produced or treated so as to have an length to diameter (L/D) ratio of less than 4:1.

Rounder crystals were found to flow better and to have a lower viscosity than non-rounded crystals. One way to prepare rounded crystals is to subject the crystals to high-shear mixing, which break off the corners of crystals so that they become more rounded.

Compositions

While crystals of sodium hypochlorite pentahydrate have been found to be relatively stable when precipitated from a liquor containing about 1% to about 5% excess sodium hydroxide, there is surprisingly, a further stability benefit achieved by adding additional base that was not present during the preparation of the bleach. The Other alkaline inorganic sodium salts can be used. Examples of suitable alkaline inorganic sodium salts include sodium hydroxide, sodium carbonate, sodium metasilicate, sodium silicate, sodium phosphate, sodium aluminate, sodium borate, or mixtures of two or more thereof may be used. In one embodiment, the alkaline inorganic sodium salt comprises NaOH. In another embodiment, the alkaline inorganic sodium salt is NaOH. KOH or potassium salts may also be used. Thus, disclosed herein are compositions comprising solid bleach, water, and a basic compound comprising sodium hydroxide, sodium carbonate, sodium metasilicate, sodium silicate, sodium phosphate, sodium aluminate, sodium borate, or mixtures of two or more thereof, where the basic compound was not prepared during the preparation of the solid bleach. Preferably, the basic compound comprises sodium hydroxide.

In one embodiment, less than 5 wt % or less than 3 wt % or less than 2 wt % or more than 0.5 wt % sodium hydroxide is added. To be clear, the added alkaline sodium salt may be liquid, solid or a combination thereof. An example of a liquid alkaline sodium salt is 50 wt % solution or higher. In one embodiment, the solution has a concentration of 25-65 wt % solution. In an embodiment, at least 35 wt % aqueous, alkaline sodium salt is used. In a further embodiment, at least a 50 wt % is used. Alternatively, 50 wt % aqueous, alkaline sodium salt is used. Solid alkaline sodium salts, such as solid NaOH, are commercially available.

Accordingly, it has been found that adding an additional base, such as an alkaline inorganic sodium salt, including for example sodium hydroxide, to the moist bleach cake confers additional stability to the bleach. There may be a small amount of residual sodium hydroxide (a base) in the bleach cake composition, however, this is typically a very small amount, such as about 0.01% or less. Accordingly, base may be added to the composition to provide a concentration range for the base which confers stability during storage. This provides stability at lower storage temperatures such as −0.5° C. up to higher storage temperatures such as 10° C., for long periods of time, such as more than 200 days without a significant drop in the concentration of sodium hypochlorite pentahydrate, such as less than a 5 wt % or a 2 wt % drop. The bleach composition having the crystals of sodium hypochlorite pentahydrate may be stored in refrigeration at lower temperatures such as −0.5° C. However, there is reduction in costs associated with the ability to store the bleach composition at higher temperatures, such as 0° C., 5° C., and even 10° C. as disclosed herein. Accordingly, the stability provided by the addition of base, or the inclusion of base at the ranges as disclosed herein, provides a significant benefit in the ability to store the bleach composition at higher temperatures in addition to low temperatures.

Accordingly, the alkaline sodium salt, or other base, that is added may not part of the bleach producing reaction, but is added after the reaction. Accordingly, this alkaline sodium salt is external to the bleach producing reaction. To be clear, the alkaline sodium salt is added to the highly concentrated bleach after it is formed. But it should be noted that if NaOH is recovered and/or isolated and/or recycled from the bleach making process, it may be added to the bleach or combined with fresh alkaline sodium salt and then added to the bleach. While more than 10% excess alkaline sodium salt may be added to the concentrated bleach, typically, less than 10 wt % is used. In one embodiment, less than about 5 wt % alkaline sodium salt may be used. In a further embodiment, more than 0.5 wt % alkaline sodium salt may be used.

The final concentration of the base in the solid bleach for storage, including any residual base from the reaction (which may be sodium hydroxide) together with the added base, such as for example also sodium hydroxide, e.g. sodium hydroxide that was not prepared during the preparation of the solid bleach, may range from about 0.6 wt % to about 4 wt %, alternatively from 0.75 wt % to about 2 wt %, alternatively from about 0.75 wt % to about 1.5 wt %, alternatively from about 0.75 wt % to about 1.5 wt %, and combinations of the aforementioned. The lower range of concentration may be greater than 0.5 wt %.

Furthermore, the solid bleach may be stored at 5° C., including about 5° C. (+/−1° C.), the concentration of base may range from about 2 wt % to 4 wt %, or alternatively from 1 wt % to 4 wt %. Furthermore, the solid bleach may be stored at 5° C., including about 10° C. (+/−1° C.), the concentration of base may range from about 0.6 wt % to 1.5 wt %, 0.75 wt % to 1.25 wt %, or alternatively from 0.6 wt % to 1.5 wt %.

The solid bleach may be stored for periods of 90 days or more, alternatively 100 days or more, alternatively 150 days or more, alternatively 190 days or more, alternatively 200 days or more, alternatively 250 days or more. The solid bleach may be stored at these time periods without a significant drop in the concentration of sodium hypochlorite pentahydrate, such as 5 wt % or less, alternatively 3 wt % or less, alternatively 2 wt % or less, alternatively 1 wt % or less, alternatively less 0.5 wt % or less. In some embodiments, at 5° C. there may be 5 wt % or less drop after 200 days, and at 10° C. there may be 2 wt % less drop after 90 days.

At the aforementioned concentrations such as from 0.75 wt % to 1.25 wt % at 10° C., the decay may be less than 0.05 wt % per day, alternatively less than 0.05 wt % per day. At t the aforementioned concentrations such as from 2 wt % to 4 wt % at 5° C., the decay may be less than 0.05 wt % per day, alternatively less than 0.05 wt % per day.

In other embodiments, the concentration of the base is less than about 3 wt % or less than about 2.5 wt %. In other embodiments, it is about 1.5 wt % to 2.5 wt % alkaline sodium salt is used. In another embodiment, 2 wt % is used. In a still further embodiments, about 2 wt % of a 50 wt % aqueous NaOH solution is added to the bleach. This product can be created by adding sodium hydroxide as a 50 wt % solution or as ground solid sodium hydroxide with essentially the same result. The solid bleach compositions further comprise about 1-5 wt % of NaCl.

In the above, the concentration of sodium hypochlorite pentahydrate in the composition may be present at an initial concentration of from about 40 to about 45 wt %, alternatively from about 41 to about 44 wt %, alternatively from about 42 wt %.

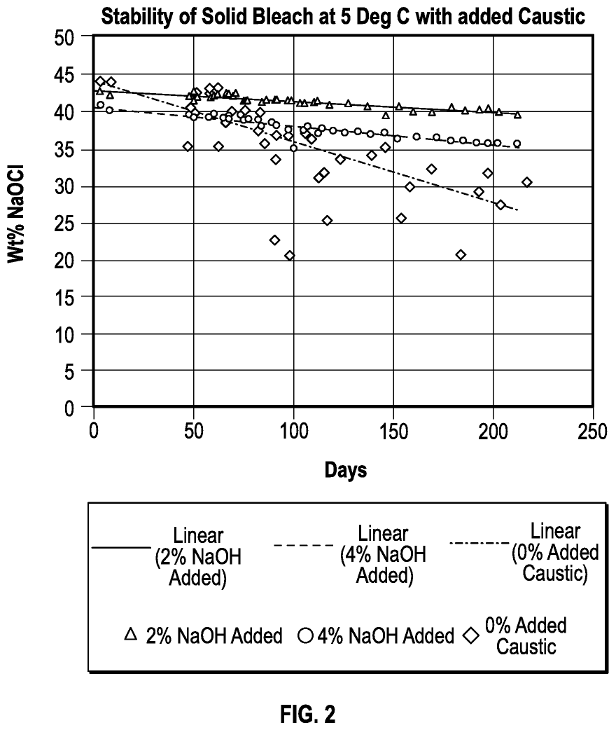

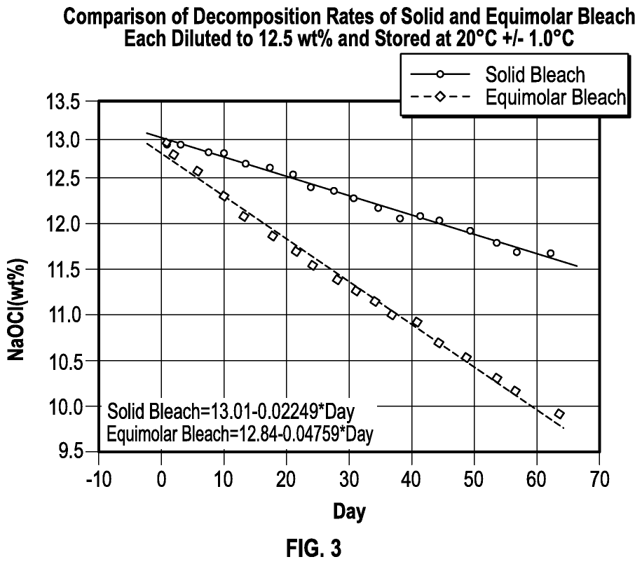

In FIG. 2 the results of storage experiments with solid bleach are shown and compared with the known decomposition rate of bleach solutions. For all storage experiments, the bleach was stored in individual containers at 5° C. over a period of 50 to 200 days. At each sampling interval, a container was opened, weighed, and dissolved in a known amount of deionized water, then analyzed, and the measured hypochlorite content was then calculated, adjusting for the dilution. The sodium hypochlorite is analyzed by taking a sample, and reacting it with a buffered solution of potassium iodide, and then titrating at least a portion of the resulting mixture with a standardized sodium thiosulfate solution.

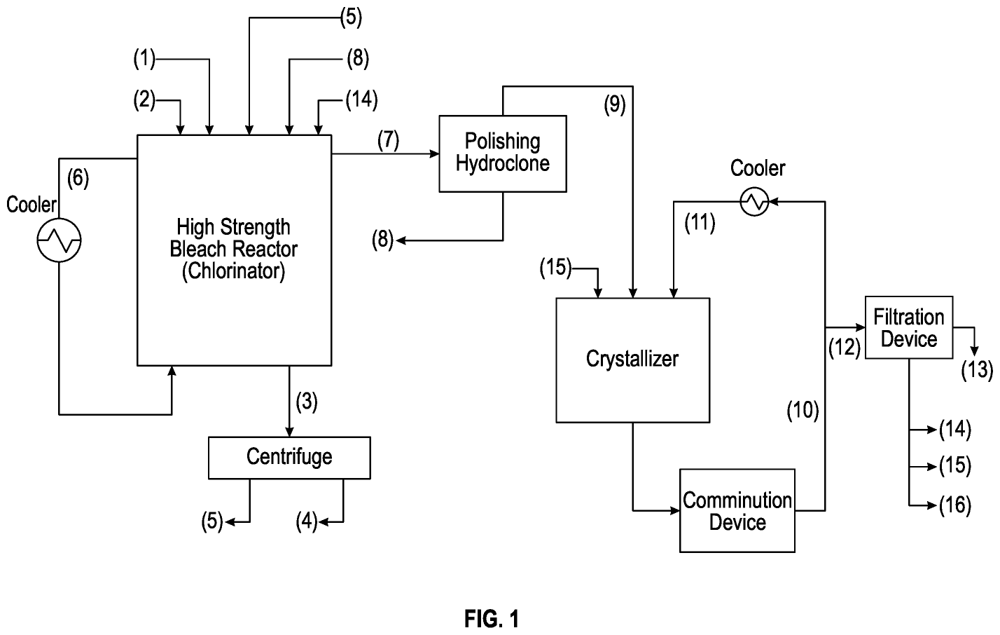

As shown in FIG. 1, in one embodiment, the basic streams of this process are as follows:

Caustic soda (NaOH, preferably 50% or greater concentration) is fed to the High Strength Bleach Reactor (Chlorinator). (Stream 1)

Chlorine (either a wet gas or a dry liquid) is also fed to the Chlorinator (stream 2). The chlorine and the NaOH react to form NaCl and NaOCl. As described above, this reaction is exothermic and the temperature in the reactor is also as described above. As the reaction proceeds, the NaCl begins to precipitate out, typically in a settling zone. A mixture of the precipitated NaCl and the aqueous NaOCl leaves the reactor (Stream 3) and enters a Centrifuge, where the solid NaCl is removed (Stream 4). If necessary, the temperature of this material may be adjusted to facilitate the removal of the NaCl. Some, if not all of the aqueous NaOCl leaving the Centrifuge is recycled to the Chlorinator (Stream 5), while the solid NaCl is isolated. While not shown in FIG. 1, the aqueous NaOCl may be treated to adjust its temperature. Typically, the aqueous NaOCl is cooled before being recycled to the Chlorinator.

As the reaction proceeds, material is withdrawn, cooled and recycled to the Chlorinator (Stream 6). Preferably, the reactor is kept at a near, constant temperature, as described above.

As the strong bleach is formed, it leaves the Chlorinator (Stream 7) and enters the Polishing Hydroclone, where additional solids are removed from the strong bleach. The materials containing the additional solids typically leave the bottom of the Hydroclone and are recycled to the chlorinator (Stream 8). If desired, some or all of the material leaving the bottom of the Hydroclone are discarded. If the reactor is designed in such a way to afford adequate separation of sodium chloride, then the use of the polishing hydroclone is optional. If the polishing hydroclone is not used, the stream leaving the reactor (Stream 7) goes to the crystallizer. While not shown in FIG. 1, the stream leaving the reactor (stream 7) may be cooled or partially cooled before entering the crystallizer. If the polishing hydroclone is not used, no streams will enter it and no streams can be recycled to it.

The material leaving the top of the Hydroclone (Stream 9) enters a crystallizer, where NaOCl pentahydrate crystals are formed. The crystals may then be comminuted in a comminution device, e.g., a macerator or other device, in order to reduce the size of the crystals. The liquid and optionally, some solid, leaving the macerator (Stream 10) are cooled and recycled to the Crystallizer (Stream 11). Comminuted crystals are then sent to a filtration device, such as a vacuum filtration device (Stream 12). The desired NaOCl pentahydrate is then isolated (Stream 13). The residual weak bleach may be recycled to the Chlorinator (Stream 14), the Crystallizer (Stream 15) or combinations thereof. Additionally, all or some of it may be purged (Stream 16).

At least some of the weak bleach may be temperature adjusted, either heated or cooled, depending on where it is to be sent.

If necessary or desired, water can be fed to the process in one or more of the following locations. It may be added to the reactor recycle and cooling loop, prior to the Chlorinator; the Crystallizer; it may be used as a wash in the vacuum filtration device; it may be as a wash for the Centrifuge; and/or as a diluent for the bleach product isolated at the end of the process. When water is added, it should not contain any compounds that will catalyze or accelerate the decomposition of the bleach. For example, cobalt and/or nickel are preferably excluded from the water. Optimally, no water is added to the process at any of these locations.

As shown in FIG. 1, various streams may be recycled to the Chlorinator or to other parts of the process. Typically, recycling streams to the Reactor or other parts of the process reduces cost and is environmentally friendly.

The bleach-containing compositions produced by the methods disclosed herein can be loaded and unloaded as a pumpable paste or slurry, or alternatively they may be handled as a solid with a packed density of at least 0.9 gms/cc. The slurries may contain more than 25 wt % sodium hypochlorite, and the solid form may have concentrations of up to 45 wt %, so that transportation weight and volume is approximately equal or smaller than the equivalent bleach produced conventionally by reaction of 50% sodium hydroxide and chlorine.

The slurry disclosed herein are stable over a period of time of at least 200 days at 5° C., without losing more than 5% of its contained hypochlorite value. And after storage at a temperature of 5° C., the chlorate formed by decomposition of the bleach is lower than amount of chlorate contained in conventional bleach containing 15% sodium hypochlorite that was stored at 5° C. And the slurries and solids can be diluted to produce bleach at all concentrations of practical use as industrial or commercial bleach products. Further, these diluted compositions can be obtained with commercially desirable levels of both total alkalinity and excess sodium hydroxide, and desirably low levels of sodium chlorate.

The solid form of bleach produced by the methods disclosed herein do not form a hard cake on storage and can be broken up with a force of less than about 10 pounds per linear inch applied to the outside of a package. Furthermore, the liquid contained in the product does not separate from the solid on storage, so the product remains homogenous. In some embodiments, the chlorate content of the solid bleach is less than about 500 ppm.

The processes disclosed herein can be run on a large scale, at locations where salt and electricity are used to produce chlorine and caustic soda. And the resulting solid bleach can be shipped over longer distances at lower shipping costs than other, less concentrated bleach solutions. The solid bleach is produced in high yield from both chlorine and caustic soda. It may be sold as concentrated bleach solution, but the byproducts account for less than about 10% of the total sodium hypochlorite produced in the reaction.

The processes disclosed herein can be operated continuously, which substantially increases the utilization of equipment dedicated for this purpose. And the processes can be run without fouling of lines and heat exchangers used for at least several hours at a time. And while the processes utilize electricity, e.g., for pumping, comminution, and refrigeration, this use is minimized. The byproducts of the processes disclosed herein may be sold as a concentrated bleach solution. These byproducts typically account for less than about 10% of the total sodium hypochlorite produced.

### Definitions

When introducing elements of the embodiments described herein, the articles “a” and “an” and “the” and “said” are intended to mean that there are one or more of the elements. The terms “comprising” and “including” and “having” are intended to be inclusive and mean that there may be additional elements other than the listed elements.

### EXAMPLES

The following examples illustrate various embodiments of the invention.

### Example 1

In example 1, bleach was prepared with an initial strength of 43.5 wt % by cooling crystallization from a bleach solution that contained 3.5% sodium hydroxide. A portion of this solid bleach was mixed in a high-shear mixing device with an amount of 50 wt % sodium hydroxide solution so that the product contained 2% sodium hydroxide by weight, and the sodium hypochlorite content was reduced to 42% by weight. This material was found to have very consistent analysis and lost strength at an average rate of 0.027% per day of its original concentration of 41.90%. The decomposition rate was measured by linear regression of the data points from analysis of the bleach taken at least once a week for a total of 200 days. The analysis was conducted by dissolving the entire stored bleach sample and using a potassium iodide/sodium thiosulfate titration method as is commonly practiced in the bleach arts.

### Example 2

In example 2, the preparation of the bleach was carried out using the same starting material as example 1, except that solid 99% sodium hydroxide was added to achieve the same 2% added sodium hydroxide content as in example 1, but with slightly less dilution of the sodium hypochlorite. The product produced in this example had a consistent analysis and lost strength at an average rate of 0.034% per day of its original concentration of 42.87 wt %.

### Example 3

In example 3, bleach was prepared in the same manner as example 1, except that no additional sodium hydroxide was added to the bleach crystals. The analysis of bleach samples during storage showed a high degree of variability, and an average decomposition rate of 0.19% per day of its original concentration of 43.5%. Thus, the material without added based had a decomposition rate that was 7.0 times higher than in Example 1 and 5.6 times higher than in Example 2.

### Example 4

In example 4, bleach was prepared as in example 1, except that 4% sodium hydroxide was added. The decomposition rate was measured to be 0.055% per day of its original concentration of 40.57%.

### Example 5

In example 5, bleach product was prepared as in example 2, except that 4% by weight of solid sodium hydroxide was added. The decomposition rate was measured to be 0.092% per day of its original concentration of 41.59%.

### Example 6

Representative data for three batches of bleach product made using the methods disclosed herein. Water content increases from sample 10 to sample 12.

| Sample # | NaOCl wt % (cake) | ClO₃-ppm (cake) | ClO₃/NaOCl Ratio |
|---|---|---|---|
| 10 | 44.32 | 241.1 | 5.4 |
| 11 | 44.07 | 292.1 | 6.6 |
| 12 | 43.91 | 323.4 | 7.4 |

The data in the above table illustrates that samples having higher moisture content tend to have higher chlorate concentration which increases the chlorate to hypochlorite ratio.

All of the above examples show that adding extra base to the concentrated bleach affords a bleach material having improved stability, when compared to bleach that did not have additional bleach added. To put it another way, the decomposition rate of the bleach composition containing extra sodium hydroxide is less than the decomposition rate of bleach compositions that do not contain any added sodium hydroxide.

The stability of bleach solutions stored at 5° C. with low salt content known in prior art with a starting concentration of 22% sodium hypochlorite by weight, which is significantly less concentrated than the bleach in the above examples, are known to lose about 0.08% per day of their initial strength. Also by reference, bleach solutions produced without precipitation of sodium chloride, i.e., equimolar bleach solutions, with a starting concentration of 16% stored at 5° C. are known to lose approximately 0.092% per day of their initial strength.

Counterexample 1: A First Single-Pass Process Modeled by Mass Balance

In a reactor where bleach is produced and salt is crystallized, chlorine gas and diluted sodium hydroxide of approximately 35.5% is fed and reacted to produce a bleach solution containing 28.4% sodium hypochlorite, 0.4% sodium chlorate, and 7.8% sodium chloride at 25 degrees C. Salt precipitates in this reactor and is removed by filtration. The salt cake removed by this process contains approximately 30% of reactor liquor by weight entrained in the solid. The filtered reactor solution is fed to a cooling crystallization step where a final temperature of 0 degrees C. is obtained and sodium hypochlorite pentahydrate crystals are produced. The precipitated crystals are then filtered off in a solid bleach product containing 9% mother liquor and an overall hypochlorite concentration of 43 wt % as sodium hypochlorite. The remaining mother liquor contains 17.1% sodium hypochlorite and 13.1% sodium chloride as well as 0.67% sodium chlorate. This liquor can be diluted to standard 12% or 15% solutions and has a hypochlorite to chloride ratio similar to that of equimolar bleach. In this example, total yield of the solid bleach product is 57.9% based on chlorine and overall bleach yield is 90.5% on chlorine. The composition of the solution bleach byproduct contains more than a desired concentration of sodium chlorate for drinking-water applications.

Counterexample 2: A Second Single-Pass Process Modeled by Mass Balance

In a reactor where bleach is produced and salt is crystallized, chlorine gas and diluted sodium hydroxide of approximately 36.5% is fed and reacted to produce a bleach solution containing 28.4% sodium hypochlorite, 0.4% sodium chlorate, and 7.8% sodium chloride at 25 degrees C. Salt precipitates in this reactor and is removed by filtration. The salt cake removed by this process contains approximately 30% of reactor liquor by weight entrained in the solid. The filtered reactor solution is fed to a cooling crystallization step where a final temperature of −5 degrees C. is obtained and sodium hypochlorite pentahydrate crystals are produced. The precipitated crystals are then filtered off in a solid bleach product containing 9% mother liquor and an overall hypochlorite concentration of 43 wt % as sodium hypochlorite. The remaining mother liquor contains 14.4% sodium hypochlorite and 14.1% sodium chloride as well as 0.72% sodium chlorate. This liquor cannot be diluted to standard 12% or 15% solutions because the hypochlorite to chloride ratio is below that of standard equimolar bleach. In this example, total yield of the solid bleach product is 62.5% based on chlorine but overall bleach yield is also 62.5% because the coproduct stream is not commercially useful.

### Example 7

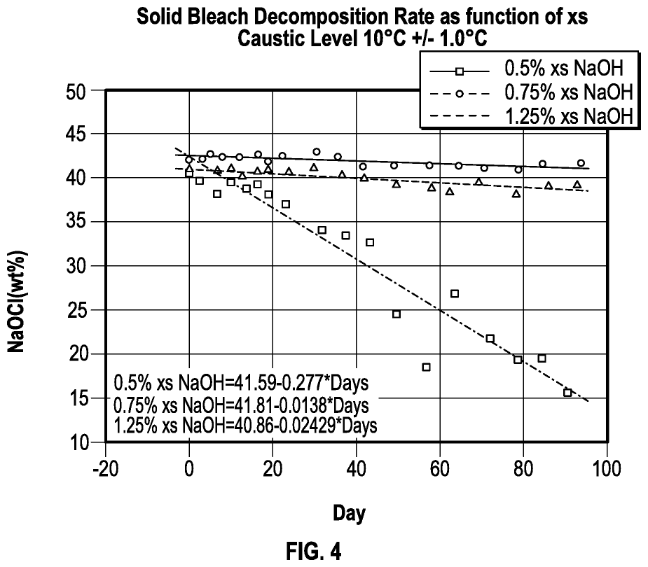

FIG. 4 illustrates solid bleach samples having sodium hydroxide present at 0.5 wt %, 0.75 wt %, and 1.25 wt % over a period of over 90 days at 10° C. Surprisingly, a change in concentration from 0.5 wt % to 0.75 wt % and up to 1.25 wt % increases the stability of the concentration of NaOCl significantly. Whereas the solid bleach having 0.5 wt % decreased significantly, dropping from about 43% to about 15% over about 95 days. On the other hand the compositions having from 0.5 wt % to 0.75 wt % maintained the concentration of with the 0.75 wt % base composition not dropping below 40 wt % NaOCl and the 1.25 wt % not dropping below 37 wt %.

FIG. 5 illustrates the hypochlorite decay at different concentrations of base (NaOH) at different temperatures. The following is a table of certain data points:

Storage at 10 C.

| | | | |
|---|---|---|---|
| Caustic | 0.5 | 0.75 | 1.25 |
| Decay Rate | 0.2462 | 0.0199 | 0.0237 |

As shown in FIG. 5, surprisingly, the particular concentration of base at from 0.75 wt % to 1.25 wt % produced a significant drop in decay rate, dropping below that of 0.05% per day at 10° C. This permits storage of the solid bleach at higher temperatures, thus providing cost savings, without significant degradation of the hypochlorite. Moreover as shown, at 5° C. there is very low decay rate, below 0.05% per day for concentrations of 2 wt % to 4 wt %.

Having described the invention in detail, it will be apparent that modifications and variations are possible without departing from the scope of the invention defined in the appended claims.

What is claimed is:

1. A process for preparing bleach, the process comprising:
making a mixture comprising sodium hydroxide, water, and chlorine in a reactor;
forming strong bleach and NaCl, wherein at least some of the NaCl is a solid;
separating strong bleach from at least some of the solid NaCl and removing material comprising at least some of the solid NaCl from the reactor;
cooling the strong bleach in a cooler to afford cooled strong bleach;
introducing the cooled strong bleach into a bleach crystallizer, where at least some bleach crystals form;
a stream comprising cooled strong bleach and bleach crystals leaves the bleach crystallizer and at least a portion of this stream enters a separator, where at least some of the bleach crystals are separated from the rest of the stream to form a solid bleach composition, wherein the solid bleach composition contain less than 10% liquid;
adding a base to the solid bleach composition.

2. The process of claim 1, wherein the solid bleach after adding the base has a concentration of base from above 0.5 wt % to 4 wt %.

3. The process of claim 1, wherein the solid bleach after adding the base has a concentration of base from above 0.75 wt % to 1.5 wt %.

4. The process of claim 3, wherein the solid bleach may be stored at 10° C. for over 80 days having a decay rate of hypochlorite of less than 0.05% per day.

5. The process of claim 3, wherein the solid bleach is stored at 10° C. for over 80 days having a decay rate of hypochlorite of less than 0.05% per day.

6. The process of claim 1, wherein the solid bleach after adding the base has a concentration of base from above 2 wt % to 4 wt %.

7. The process of claim 6, wherein the solid bleach may be stored at 5° C. for over 100 days having a decay rate of hypochlorite of less than 0.05% per day.

8. The process of claim 7, wherein the solid bleach is stored at 5° C. for over 80 days having a decay rate of hypochlorite of less than 0.05% per day.

9. The process of claim 1, wherein the base comprises sodium hydroxide.

10. The process of claim 1, wherein the solid bleach composition contain less than 5% liquid.

11. A composition comprising solid bleach, less than 10% liquid, and a basic compound added after formation of the solid bleach, wherein the total amount of base compounds is from above 0.5 wt % to 4 wt %.

12. The composition of claim 11, wherein the total concentration of base in the composition from above 0.75 wt % to 1.5 wt %.

13. The process of claim 12, wherein the composition may be stored at 10° C. for over 80 days having a decay rate of hypochlorite of less than 0.05% per day.

14. The composition of claim 11, wherein the total concentration of base in the composition from above 3 wt % to 4 wt %.

15. The composition of claim 14, wherein the composition may be stored at 5° C. for over 80 days having a decay rate of hypochlorite of less than 0.05% per day.

16. The composition of claim 14, wherein the concentration of sodium hypochlorite pentahydrate is from 40 wt % to 45 wt %.

17. A composition of claim 11 having less than 5% liquid.
